(19) United States
(12) Patent Application Publication
(10) Pub. No.: US 2025/0083609 A1
(43) Pub. Date: Mar. 13, 2025

(54) CONSOLE DEVICE

(71) Applicant: SEOYONE E-HWA CO., LTD., Anyang (KR)

(72) Inventor: Yong Su LEE, Siheung (KR)

(21) Appl. No.: 18/822,634

(22) Filed: Sep. 3, 2024

(30) Foreign Application Priority Data
Sep. 13, 2023 (KR) 10-2023-0121900

(51) Int. Cl. B60R 7/04; E05B 83/32

(52) U.S. Cl. CPC B60R 7/04; E05B 83/32

(57) ABSTRACT

Proposed is a console device having a technology of a console cover opening and closing control structure in which a console cover is operable of being selectively opened in one of a front side and a rear side while maintaining the other side, which is not opened, securely locked.

### CROSS REFERENCE TO RELATED APPLICATION

The present application claims priority to Korean Patent Application No. 10-2023-0121900, filed Sep. 13, 2023, the entire contents of which are incorporated herein for all purposes by this reference.

### BACKGROUND OF THE INVENTION

### Field of the Invention

The present disclosure relates to a console device. More particularly, the present disclosure relates to a technology of a console cover opening and closing control structure for controlling a console cover such that a console cover is capable of being selectively opened either in a front direction or a rear direction while opening and closing of the console cover are stably and reliably performed.

### Description of the Related Art

In the interior of a vehicle, a console device is mounted between a driver's seat and a passenger seat. The console cover of the console device serves as an armrest, providing comfort to passengers. Also, the console cover can be opened, allowing objects to be stored in an compartment inside the console device.

Since a conventional console device opens only in a front direction, it is convenient for passengers seated in a driver's seat or a passenger seat to access. However, there is an inconvenience for passengers seated in a rear seat as they cannot easily open the console device.

In order to solve this inconvenience, a console device capable of being opened in both front and rear directions or a console device capable of being opened in both left and right directions has been proposed.

In such a console device capable of being opened in both front and rear directions, there is a problem that a console cover is separated from the console device when respective operation button in both directions are simultaneously operated.

In addition, the adoption of a complex structure for opening the console cover in both directions leads to increase in the number of components increases. Accordingly, this reduces the operation reliability of the console device and drives up the manufacturing cost increases.

Furthermore, because the console cover uses a hinge structure that allows it to open in both directions, there is a problem that the hinge on one side does not stably support when the cover is opened in the opposite direction.

### SUMMARY OF THE INVENTION

Accordingly, the present disclosure has been made keeping in mind the above problems occurring in the related art, and an objective of the present disclosure is to provide a console device configured such that a console cover is capable of being opened in any one direction among a front direction and a rear direction.

Particularly, the present disclosure is intended to solve a problem that a console cover is separated from a console device when respective operation buttons in both sides of the console device are simultaneously operated.

In addition, the present disclosure is intended to solve a problem that the number of components increases as a complex structure for opening a console cover in both directions is adopted, and is intended solve a problem that the operation reliability of a console device decreases and the manufacturing cost increases.

Furthermore, the present disclosure is intended to solve a problem that a hinge structure in the other direction does not stably support a rotation of a console cover when the hinge structure is opened in one direction since the hinge structure for opening the console cover in both directions is adopted.

The objectives of the present disclosure are not limited thereto, and other objectives and other advantages of the present disclosure will be understood from the following description.

In order to achieve the objectives as described above, according to an aspect of the present disclosure, there is provide a console device including: a rod member configured to be moved in a longitudinal direction according to an operation of an operation button unit that performs opening of a console cover, the rod member being provided with a guide hole having a predetermined length in a diagonal direction relative to the longitudinal direction; a locking control unit provided with a locking adjustment protrusion inserted into and coupled to the guide hole, the locking control unit being configured to be moved in a horizontal direction according to a guide of the guide hole upon rod member's longitudinal movement such that a portion of a distal end of a locking rod of the locking control unit is inserted into or pulled out from a locking hole of a console body, thereby controlling locking and releasing of the console cover; and a base plate on which the rod member and the locking control unit are seated and supported.

As an example, the rod member may include: a center rod elongated in the longitudinal direction; and a wing which extends outward from side surfaces of the center rod and which is provided with the guide hole, and wherein the locking control unit may include: a locking adjustment member having a first side provided with the locking adjustment protrusion and being configured to be moved in the horizontal direction according to the guide of the guide hole; and the locking rod fastened to a second side of the locking adjustment member and configured to be moved by the locking adjustment member such that the portion of the distal end of the locking rod is inserted into or pulled out from the locking hole of the console body.

As an example, the wing may include a left wing and a right wing on both left and right sides of the center rod, and the locking control unit may include a left locking control unit corresponding to the left wing and a right locking control unit corresponding to the right wing.

As an example, the locking control unit may further include a support plate which is fixed and fastened to the base plate and which provides a movement space of the center rod in the longitudinal direction, the support plate being configured to support the locking adjustment member and to support the movement in the horizontal direction of the locking adjustment member. Furthermore, the operation button unit may include an operation button body, an operation button cover fixed and mounted on the support plate and configured to support the operation button body and to support a movement in the longitudinal direction of the operation button body, and an operation button return spring having a first side fastened to the operation button body and having a second side fastened to the operation button cover such that a position of the operation button body is returned.

As an example, the rod member may further include a center rod return mechanism having a first side fastened to the center rod and having a second side fastened to the base plate such that an elastic force is applied to the center rod return mechanism as the center rod return mechanism is pressed according to the movement of the center rod, the center rod return mechanism being configured to return a position of the center rod by a restoration force according to the elastic force.

As an example, the guide hole may be configured such that an angle of the guide hole inclined in the diagonal direction relative to the longitudinal direction is adjusted, so that an amount of operation work required for the operation button unit for opening the console cover may be adjusted.

As an example, the guide hole may be configured such that the guide hole is formed in an arc shape that protrudes forward in the diagonal direction or in an arc shape that protrudes rearward in the diagonal direction, so that an amount of operation work required for the operation button unit for opening the console cover may be adjusted.

Furthermore, the operation button unit may include a front operation button unit and a rear operation button unit. Also, the rod member and the locking control unit may include: a front rod member and a front locking control unit that are disposed on a front region of the base plate such that a front side of the console cover is capable of being opened according to an operation of the front operation button unit; and a rear rod member and a rear locking control unit that are disposed on a rear region of the base plate such that a rear side of the console cover is capable of being opened according to an operation of the rear operation button unit.

Preferably, when the front side of the console cover is opened, a rear locking rod of the rear locking control unit may be rotated while being in a state in which a portion of a distal end of the rear locking rod is inserted into a rear locking hole of the console body, so that the rear locking rod may function as a hinge. Furthermore, when the rear side of the console cover is opened, a front locking rod of the front locking control unit may be rotated while being in a state in which a portion of a distal end of the front locking rod is inserted into a front locking hole of the console body, so that the front locking rod may function as a hinge.

Furthermore, a front center rod of the front rod member and a rear center rod of the rear rod member may be disposed such that a distal end of the front center rod and a distal end of the rear center rod correspond to each other along the longitudinal direction, and the console device may further include a console opening direction adjustment unit disposed between the front center rod and the rear center rod and configured to restrict, when the console cover is opened in either one of a front direction and a rear direction, the console cover from being opened in an opposite direction.

As an example, the console opening direction adjustment unit may include: a guide partition wall configured to guide the movement in the longitudinal direction of the front center rod and the rear center rod; and an open space in which the distal end of any one selected from the front center rod and the rear center rod is capable of being moved therein, wherein the open space may have a length where the distal end of any one among the front center rod and the rear center rod is moved and is in contact with the distal end of the other one so as to open the console cover in any one direction selected from the front direction and the rear direction.

As an example, the console device may further include a lifting mechanism which is disposed in the console body and in which an elastic force is applied as the lifting mechanism is pressed by the console cover when the console cover is closed, the lifting mechanism being configured to lift up the console cover by a restoration force when the console cover is opened.

As an example, the guide hole may be in a long hole shape and is diagonally oriented such that a front end of the guide hole is positioned relatively inner side than a rear end of the guide hole.

According to the present disclosure, opening and closing of the console cover may be stably and reliably performed, and the console cover may be selectively opened in the front direction and the rear direction.

Particularly, since the guide hole in the diagonal direction is provided in the rod member that is moved in the longitudinal direction according to the operation of the operation button such that the horizontal movement of the locking rod is controlled through the guide of the guide hole, opening and closing of the console cover may be stably and reliably performed with a simple structure.

Furthermore, since the amount of operation work required for the operation button unit for opening the console cover may be adjusted by adjusting the angle inclined in the diagonal direction of the guide hole guiding opening of the console cover or by forming the guide hole in the arc shape that protrudes forward or rearward in the diagonal direction, and the operation feeling may be variously modified accordingly.

Furthermore, in the present disclosure, since the opening direction of the console cover in the console device capable of being opened in both directions is capable of being selectively controlled by adopting the console opening direction adjustment unit, the problem that the front side and the rear side of the console cover are simultaneously opened and the console cover is separated from the console device may be solved.

The effects of the present disclosure are not limited to those mentioned above, and other effects not mentioned will be clearly understood by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating an example of a console device according to the present disclosure;

FIGS. 2A and 2B are views illustrating opened states of an embodiment of the console device according to the present disclosure in both directions, FIG. 2A showing an opened state in one direction and FIG. 2B showing an opened state in the opposite direction;

FIG. 3 is an exploded perspective view illustrating an embodiment of the console device according to the present disclosure;

FIG. 4 is an exploded perspective view illustrating an embodiment of a console cover opening and closing device in the console device according to the present disclosure;

FIG. 5 and FIG. 6 are exploded perspective views illustrating each configuration of an embodiment of the console cover opening and closing device according to the present disclosure;

FIG. 7 and FIG. 8 are views illustrating an example of implementing a locking function and a hinge function of a console cover in the console device according to the present disclosure;

FIG. 9 to FIG. 10D are views illustrating operation diagrams of an embodiment of a lifting mechanism in the console device according to the present disclosure;

FIGS. 11A, 11B, 11C and FIGS. 12A, 12B, 12C are views illustrating operation diagrams of an embodiment of the console cover opening and closing device in the console device according to the present disclosure;

FIG. 13A to FIG. 16B are views illustrating various embodiments of the console cover opening and closing device for adjusting an amount of operation work for opening the console cover in the console device according to the present disclosure; and

FIG. 17 and FIG. 18 are views illustrating an embodiment of the console cover opening and closing device for opening the console cover in both directions in the console device according to the present disclosure.

### DETAILED DESCRIPTION OF THE INVENTION

Hereinafter, exemplary embodiments of the present disclosure will be described in detail with reference to the accompanying drawings, but the present disclosure is not limited or restricted to the described embodiments.

In order to explain the present disclosure, the operational advantages of the present disclosure, and the objectives achieved by the practice of the present disclosure, the embodiments of the present disclosure are exemplified below and will be described with reference thereto.

First, the terms used in this application are only used to describe specific embodiments, and are not intended to limit the present disclosure, and a singular expression may include a plural expression unless the context clearly indicates otherwise. In addition, it should be understood that in the present disclosure, terms such as “comprise” or “have” are intended to designate that a feature, number, step, operation, component, part, or combination thereof described in the specification exists, and do not preclude the possibility of addition or existence of one or more other features or numbers, steps, operations, components, parts, or combinations thereof.

In describing the present disclosure, when it is determined that a detailed description of a related known configuration or function may obscure the gist of the present disclosure, the detailed description thereof will be omitted.

In the present disclosure, there is provided a technology of a console cover opening and closing control structure, which allows a console cover to be selectively opened in both the front direction and the rear direction while ensuring stable and reliable operation.

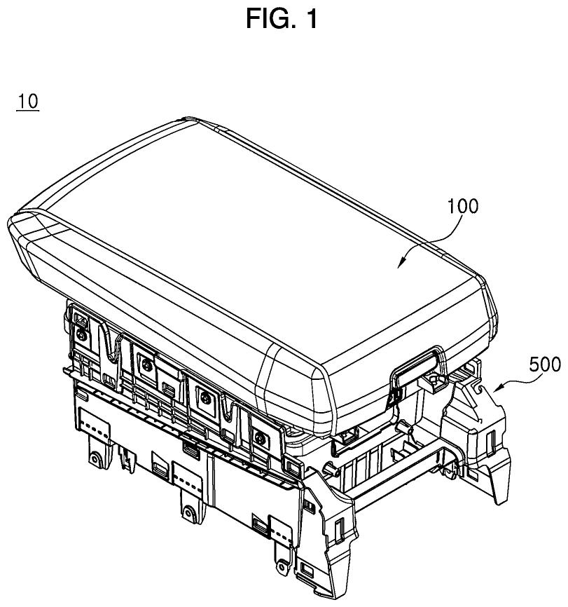

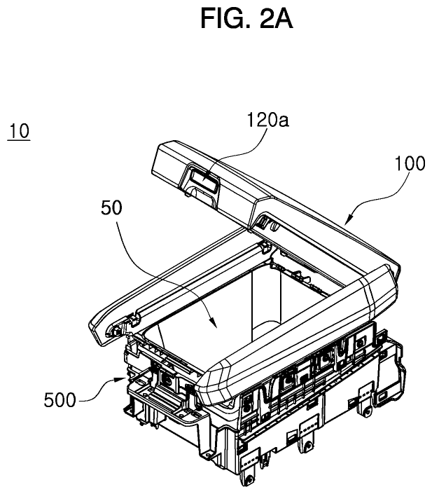

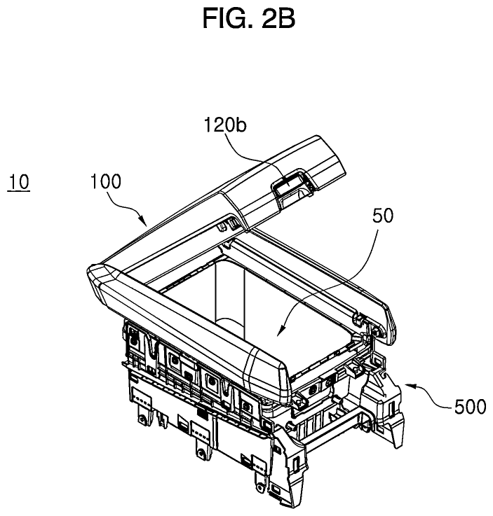

FIG. 1 is a view illustrating an example of a console device according to the present disclosure, and FIGS. 2A and 2B are views illustrating opened states of an embodiment of the console device according to the present disclosure in both directions, respectively, namely, FIG. 2A showing an opened state in one direction and FIG. 2B showing an opened state in the opposite direction.

A console device 10 may be disposed inside of the interior of a vehicle. As an example, the console device 10 may be disposed between a driver's seat and a passenger seat. As another example, the console device 10 may be disposed as a moving console so that the position of the console device 10 may be adjusted in the front/rear direction and an internal space of the vehicle can be fully utilized according for application in an autonomous driving vehicle.

The console device 10 may include, among others, a console body 500, and a console cover 100. A storage space 50 capable of storing an object therein may be provided inside the console body 500. The console cover 100 is supported on the console body 500 and is mounted on an upper portion of the console body 500. The console cover 100 is capable of closing or opening the storage space 50. Furthermore, the console cover 100 may function as an armrest for providing convenience to a passenger.

The console device 10 proposed in the present disclosure may be the console device 10 configured such that the console cover 100 is capable of being selectively opened in a front direction or a rear direction.

For example, as illustrated in FIG. 2A, a front operation button unit 120a, which allows the console cover 100 to be opened in the front direction, may be disposed on the front side of the console cover 100. This setup enables a passenger to open the console cover 100 in the front direction by controlling a front operation button.

In addition, as illustrated in FIG. 2B, a rear operation button unit 120b, which allows the console cover 100 to be opened in the rear direction, may be disposed on the rear side of the console cover 100. This setup enables a passenger to open the console cover 100 in the rear direction by controlling a rear operation button.

As such, in the present disclosure, the console device 10 is configured such that the console cover 100 is capable of being selectively opened in the front direction and the rear direction, and the console device 10 will be described in detail through specific embodiments.

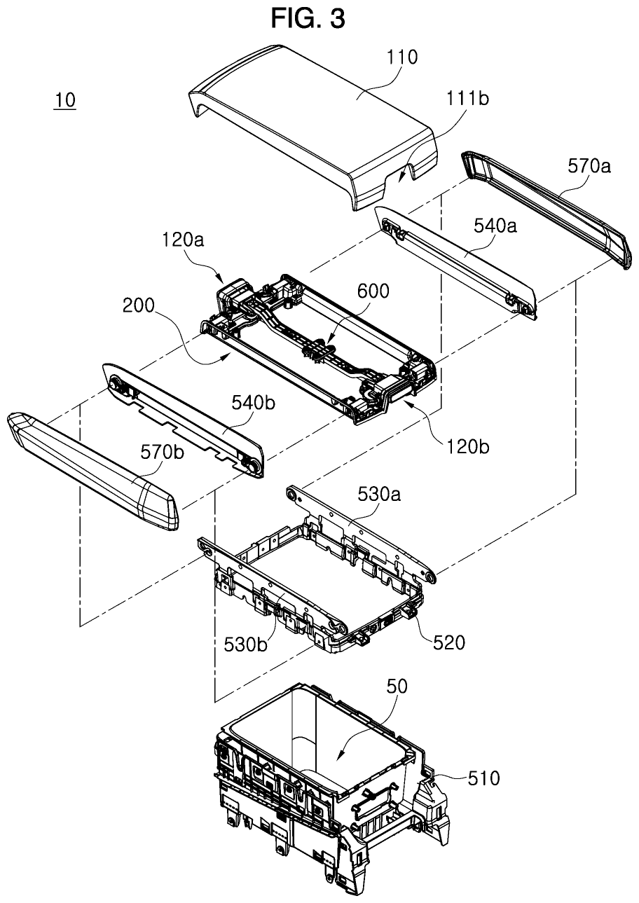

FIG. 3 is an exploded perspective view illustrating an embodiment of the console device according to the present disclosure.

The console device 10 may include the console body 500 and the console cover 100.

The console body 500 may include, among others, a body frame 510, a support frame 520, left and right guide plates 540a and 540b, and left and right side covers 570a and 570b.

The body frame 510 may be provided with the storage space 50 capable of storing an object therein. The body frame 510 may be fixedly disposed on a specific position in the vehicle. For example, the body frame 510 may be fixedly disposed between the driver's seat and the passenger seat. Alternatively, the body frame 510 may be coupled to a moving device (not illustrated), so that a position of the body frame 510 is capable of being moved inside the vehicle.

Throughout the specification, the front side, the rear side and the left side, the right side of the console device may be defined based on the forward direction, the rear direction and the left side, the right side of the vehicle in which the console device is installed assuming that the console device is installed between the driver's seat and the passenger seat.

The support frame 520 may be coupled to an upper portion of the body frame 510. The support frame 520 may support opening and closing of the console cover 100 while supporting the console cover 100. Both sides (i.e., left and right sides) of the support frame 520 may be respectively provided with support legs 530a and 530b that extend upward.

The guide plates 540a and 540b and the side covers 570a and 570b may be coupled and fastened to each other around the support legs 530a and 530b (i.e., having the support legs 530a and 530b therebetween). That is, support leg 530a may be coupled with the guide plate 540a and the side cover 570a such that, when coupled, the support let 530a is disposed between the guide plate 540a and the side cover 570a. The guide plate 540b, the side cover 570b and the support leg 530b may be coupled in a similar manner.

In a state in which the guide plates 540a and 540b and the side covers 570a and 570b are coupled to each other around the both support legs 530a and 530b of the support frame 520, the console cover 100 may be coupled in the middle between the support legs 530a and 530b.

The console cover 100 may include a console cover opening and closing device 200 and an upper cover 110.

When both of the front side and the rear side of the console cover 100 are closed, the console cover opening and closing device 200 may restrict opening of the console cover 100 by being coupled to the guide plates 540a and 540b.

In addition, according to the operation of the operation button units 120a and 120b by the passenger, the console cover opening and closing device 200 is configured such that the console cover 100 can be opened in one direction-either the front or rear—while the opposite side of the console cover 100 is supported and rotated on the guide plates 540a and 540b, thereby allowing a control of the selective opening of the console cover 100 in both directions.

The upper cover 110 may cover an upper portion of the console cover opening and closing device 200 so that the configuration of the console cover opening and closing device 200 is not exposed. Here, the upper cover 110 may function as an armrest for providing convenience to the passenger as well.

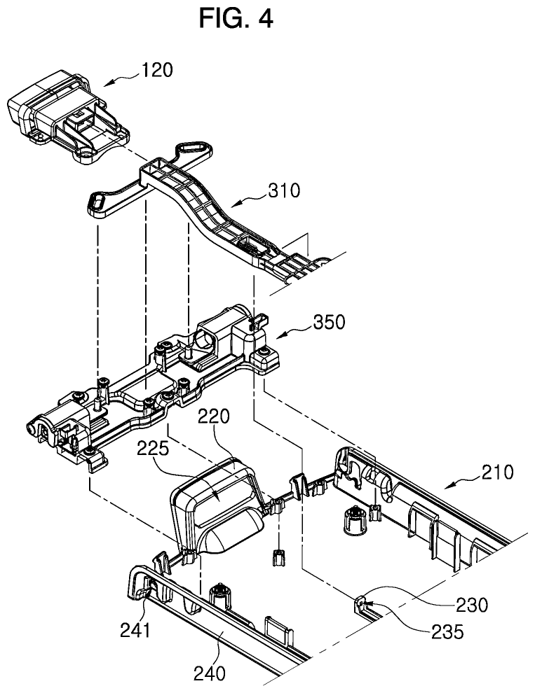

The console cover opening and closing device 200, which controls the opening and closing operation of the console cover 100, will be described with reference to FIG. 4 to FIG. 6.

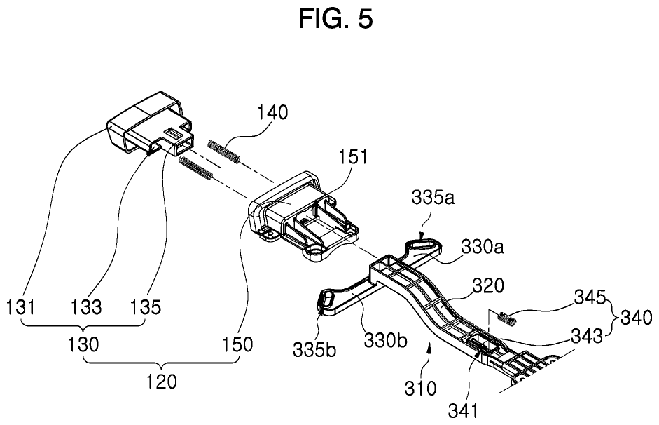

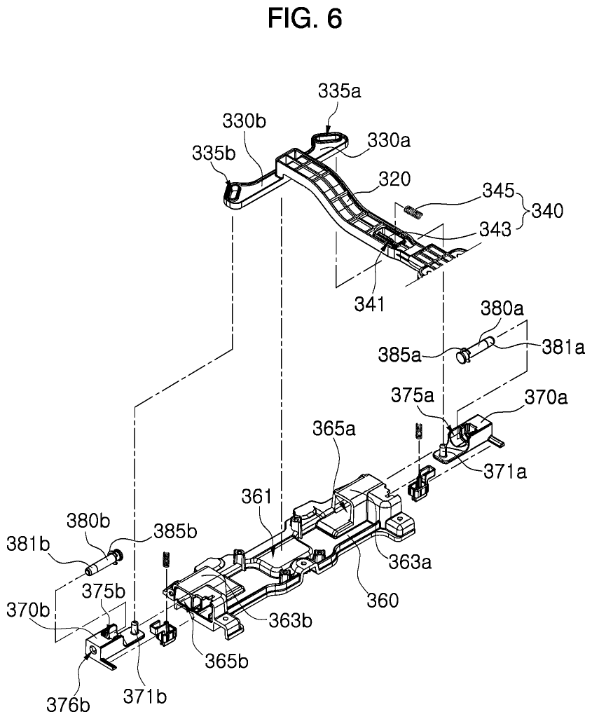

FIG. 4 is an exploded perspective view illustrating an embodiment of a console cover opening and closing device in the console device according to the present disclosure, and FIG. 5 and FIG. 6 are exploded perspective views illustrating each configuration of an embodiment of the console cover opening and closing device according to the present disclosure.

In the console cover opening and closing device 200, the mechanisms for opening and closing the front side of the console cover 100 and the configuration for opening and closing the rear side of the console cover 100 are symmetrically similar to each other. Therefore, in FIG. 4 to FIG. 6, the console cover opening and closing device 200 will be described without distinguishing the front side and the rear side thereof.

The console cover opening and closing device 200 may include, among others, the operation button unit 120, a base plate 210, the rod member 310, and the locking control unit 350.

In a state in which the operation button unit 120, the rod member 310, the locking control unit 350, together with other elements are mounted on an upper portion of the base plate 210, the upper cover 110 may be mounted on the upper portion of the base plate 210 such that the upper cover 110 covers the upper portion of the base plate 210.

The operation button unit 120 may include, among others, an operation button body 130, an operation button support cover 150, and an operation button return spring 140.

The operation button body 130 may include a button part 131 at one side that is operated by the passenger. In the middle of the operation button body 130, a return spring mounting part 133 is provided such that, a first side of the operation button return spring 140 is inserted into the return spring mounting part 133. The operation button body 130 may include an operation part 135 at the opposite side such that the operation part 135 is in contact with a distal end of a center rod 320 of the rod member 310. The operation part 135 is configured to push and move the center rod 320 rearward in a longitudinal direction thereof according to the operation of the passenger.

Throughout the specification, the longitudinal direction refers to a direction in which the center rod 320 is elongated and is the same direction from the front side to the rear side. The movement rearward refers to movement in the direction in which the button part 131 is pushed. Also, an upward direction (i.e. a direction from the console body 500 toward the console cover 100) and a downward direction (i.e., a direction from the console cover 100 toward the console body 500) may be collectively referred to as a height direction.

The operation button support cover 150 may be provided with an operation button insertion hole 151 into which a portion of the operation button body 130 is inserted. Furthermore, in a state in which the portion of the operation button body 130 is inserted into the operation button insertion hole 151, the operation button body 130 may be moved while the operation button body 130 is supported through the operation button support cover 150 according to the operation of the passenger.

The operation button support cover 150 may be fixed and mounted on a support plate 360 of the locking control unit 350, and a front region of the operation button support cover 150 may be inserted into a support hole 225 of an operation button support part 220 provided on the base plate 210 and may be supported in the support hole 225.

A second side of the operation button return spring 140 may be connected to the operation button support cover 150. The operation button body 130 may be pushed rearward according to the operation of the button part 131 by the passenger, and the operation button return spring 140 may be pressed between the operation button body 130 and the operation button support cover 150, so that an elastic force may be provided. Furthermore, when the operation of the button part 131 by the passenger is released, the operation button return spring 140 may push and return the operation button body 130 to an original position by a restoration force while the operation button return spring 140 is supported by the operation button support cover 150.

The rod member 310 may include, among others, the center rod 320, left and right wings 330a and 330b, and a center rod return mechanism 340.

The center rod 320 may be formed such that the center rod 320 extends in a longitudinal direction thereof. An end region of a front end of the center rod 320 may be in contact with the operation part 135 of the operation button body 130. The center rod 320 may be pushed and moved along the longitudinal direction as the user operates the operation button unit 120.

The wings 330a and 330b may be provided such that the wings 330a and 330b extend outward to side surfaces of the center rod 320. The wings 330a and 330b may extend perpendicularly to the longitudinal direction from the front end of the center rod 320. Guide holes 335a and 335b, with a predetermined length oriented diagonally relative to an extension direction of the wings 330a and 330b, may be provided in the wings 330a and 330b. The guide holes 335a and 335b may be long holes having the predetermined length. The guide holes 335a and 335b in a long hole shape is diagonally oriented such that front ends of the guide holes 335a and 335b are positioned relatively inner side than the rear ends of the guide holes 335a and 335b.

Throughout the specification, the direction in which the wings 330a and 330b extends from the center rod 320 may be referred to as an outward direction. Also, an opposite direction to the outward direction, which is a direction from distal ends of the wings 330a and 330b toward the center rod 310, may be referred to as an inward direction. A side positioned relatively outward may be referred to as an outer side and a side positioned relatively inward may be referred to as an inner side. The outward direction and the inward direction may be collectively referred to as a horizontal direction.

The length of the guide holes 335a and 335b may be set in consideration of a movement distance of the center rod 320 according to the operation of the operation button unit 120 and a movement distance of locking rods 380a and 380b for opening and closing the console cover 100. This will be described in more detail in an embodiment later.

The center rod 320 may be provided with the right wing 330a and the left wing 330b which extend toward the left and right side surfaces of the center rod 320, respectively. The right guide hole 335a may be provided in the right wing 330a, and the left guide hole 335b may be provided in the left wing 330b. The right wing 330a and the left wing 330b, including the guide holes 335a and 335b, may be formed in shapes symmetrical to each other with respect to the center rod 320. The guide holes 335a and 335b may be formed at ends of the wings 330a and 330b, respectively.

The center rod return mechanism 340 may return the center rod 320, which has been moved in the longitudinal direction, to the original position according to the operation of the operation button unit 120.

As an example, the center rod return mechanism 340 may be disposed in a middle end of the center rod 320. A through hole 341 may be provided in the middle end of the center rod 320, a center rod return bar 343 that protrudes rearward from an inner side wall of the through hole 341 may be formed, and a center rod return spring 345 may be mounted on the center rod return bar 343.

A center rod return support protrusion 230 which protrudes upward and which corresponds to a position of the through hole 341 of the center rod 320 may be provided on the base plate 210. A support hole 235 into which the center rod return bar 343 is inserted and in which the center rod return bar 343 is capable of being moved may be formed in the center rod return support protrusion 230.

In a state in which the center rod return spring 345 is mounted on the center rod return bar 343, a distal end of the center rod return bar 343 may be inserted into and fastened to the support hole 235 of the center rod return support protrusion 230.

The locking control unit 350 may include, among others, the support plate 360, locking adjustment members 370a and 370b, and the locking rod 380a and 380b.

The support plate 360 may be fixed and mounted on the base plate 210.

The support plate 360 may provide a movement space 361 in which the center rod 320 is capable of being moved in the longitudinal direction of the center rod 320.

Locking adjustment member fastening parts 363a and 363b to which the locking adjustment members 370a and 370b are fastened may be provided on both left and right sides of the support plate 360.

As an example, the locking adjustment member fastening parts 363a and 363b may be formed in tunnel shapes, and may be provided with locking adjustment member movement spaces 365a and 365b so that the locking adjustment members 370a and 370b are capable of being moved in the horizontal direction within the tunnel shapes of the locking adjustment member fastening parts 363a and 363b.

The right locking adjustment member 370a may be fastened to the right side of the support plate 360, and the left locking adjustment member 370b may be fastened to the left side of the support plate 360.

Locking adjustment protrusions 371a and 371b which protrude upward may be provided on each first side of the locking adjustment members 370a and 370b. The locking adjustment protrusions 371a and 371b may be inserted into and fastened to the guide holes 335a and 335b provided in the wings 330a and 330b of the center rod 320.

The locking adjustment protrusions 371a and 371b may be moved according to a guide of the guide holes 335a and 335b. As the locking adjustment protrusions 371a and 371b are moved, the locking adjustment members 370a and 370b may be moved in the horizontal direction.

Locking rod fastening parts 375a and 375b into which the locking rods 380a and 380b are inserted and fastened may be provided on each second side of the locking adjustment members 370a and 370b. The second sides of the locking adjustment members 370a and 370b may be positioned relatively outward than the first sides of the locking adjustment members 370a and 370b. Slots into which protrusion parts 385a and 385b of the locking rods 380a and 380b are inserted may be provided in the locking rod fastening parts 375a and 375b. Through holes 376a and 376b into which catching parts 381a and 381b of the locking rods 380a and 380b are inserted and penetrate may be formed in each distal end of the locking rod fastening parts 375a and 375b.

The protrusion parts 385a and 385b may be provided along each inner region circumference of the locking rods 380a and 380b, and the catching parts 381a and 381b may be provided on each outer distal end of the locking rods 380a and 380b.

The locking rods 380a and 380b may be inserted into the locking rod fastening parts 375a and 375b of the locking adjustment members 370a and 370b such that the catching parts 381a and 381b pass through the through holes 376a and 376b of the locking adjustment members 370a and 370b and the catching parts 381a and 381b exposed outwardly, and the protrusion parts 385a and 385b may be inserted into the slots of the locking adjustment members 370a and 370b such that the protrusion parts 385a and 385b are fixed and mounted in the slots.

On each of both sides of the base plate 210, a side partition wall 240 may be provided. Also, on each of both side partition walls, a locking rod moving hole 241 is provided. Through the locking rod moving holes 241 on both sides, the locking rods 380a and 380b of the locking control unit 350 pass and are capable of being moved. The locking rods 380a and 380b may be inserted into or pulled out from locking holes provided in the guide plates 540a and 540b while the locking rods 380a and 380b pass through and move in the locking rod moving holes 241 provided in the side partition walls 240 of the base plate 210.

The locking rods 380a and 380b may perform a locking function that closes the opening of the console cover 100 at one side (either front or rear), and may also perform a hinge function that supports the rotation of the console cover 100 when the console cover 100 is opened at the opposite side (either rear or front, respectively).

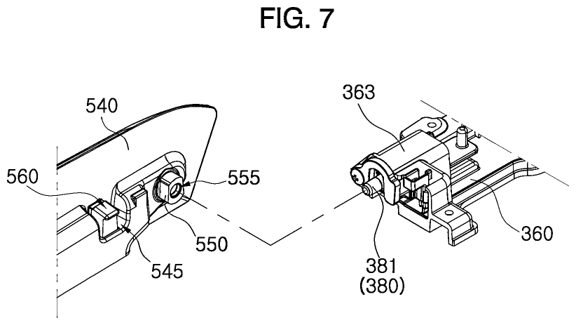

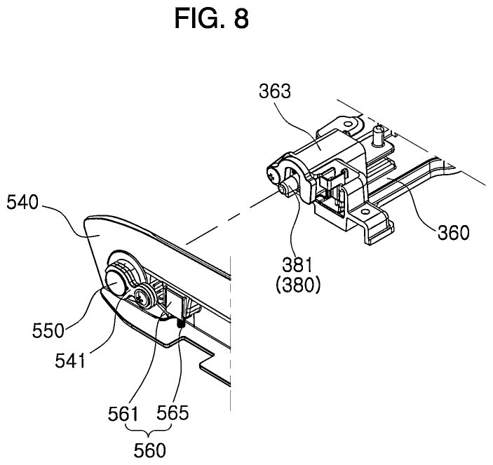

In this regard, an example of implementing the locking function and the hinge function of the console cover in the console device according to the present disclosure illustrated in FIG. 7 and FIG. 8 will be described.

In FIG. 7 and FIG. 8, the base plate 210 is omitted for convenience of description.

The guide plate 540 is provided with a catching member 550, and the catching member 550 may be mounted in the guide plate 540 by penetrating the guide plate 540. A locking hole 555 may be provided in a first side of the catching member 550 corresponding to the catching part 381 of the locking rod 380. The first side of the catching member 550 may mean an inner side of the catching member 550.

As the locking rod 380 is supported by the locking adjustment member fastening part 363 of the support plate 360 and the locking rod 380 is moved outward in the horizontal direction, the catching part 381 of the locking rod 380 is inserted into the locking hole 555 of the catching member 550, so that the console cover 100 may be closed and opening of the console cover 100 may be restricted. In other words, for example, when the catching part 381 of the locking rod 380 is inserted into the locking hole 555 of the catching member 550 at the front side of the console cover 100, the front side of the console cover 100 is locked and its opening is restricted.

Conversely, as the locking rod 380 is moved inward in the horizontal direction toward an inside of the locking adjustment member fastening part 363 of the support plate 360, the catching part 381 of the locking rod 380 is pulled out from the locking hole 555 of the catching member 550, so that the console cover 100 may be opened. In other words, for example, when the catching part 381 of the locking rod 330 is pulled out from the locking hole 555 of the catching member at the front side of the control cover 100, the front side of the console cover 100 is unlocked and becomes a state available to be opened.

A slewing ring 541 may be provided by being fixed and mounted on the guide plate 540. A second side (i.e., outer side) of the catching member 550 is fastened to the slewing ring 541. The catching member 550 may be rotated on the slewing ring 541 while the catching member 550 is held and supported on the slewing ring 541. A bearing may be provided so as to facilitate the rotation of the catching member 550. For example, the catching member 550 may be configured as a bearing and a member of the locking hole 555 by fitting the member of the locking hole 555 on the bearing.

Furthermore, a lifting mechanism 560 may be provided on the guide plate 540. The lifting mechanism 560 may include, among others, a lifting block 561, a lifting spring 565.

The lifting mechanism 560 is configured to lift up the console cover 100 when the operation of the operation button unit 120 is operated by the passenger at the beginning of the opening process, thereby assisting the passenger in more easily opening the console cover 100.

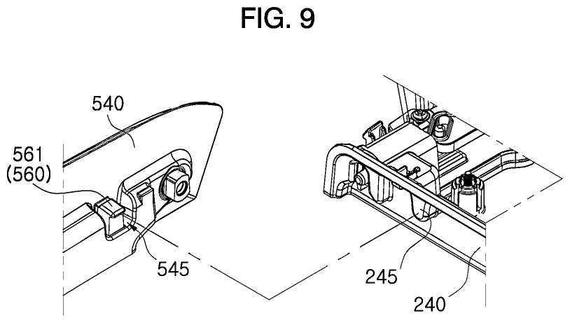

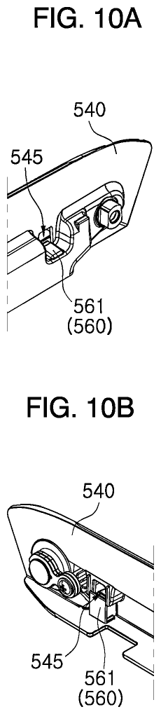

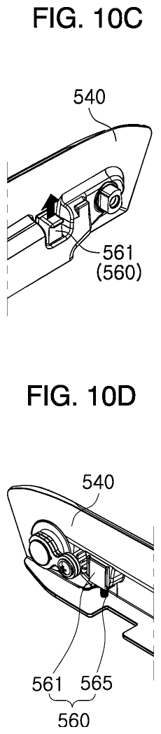

FIG. 9 to FIG. 10D are views illustrating operation diagrams of an embodiment of the lifting mechanism in the console device according to the present disclosure.

A lifting protrusion 245 may be provided on the side partition wall 240 of the base plate 210, and the lifting mechanism 560 may be provided on the guide plate 540 such that the lifting mechanism 560 corresponds to the lifting protrusion 245 of the base plate 210.

The listing mechanism 560 may include, among others, the lifting block 561, and the lifting spring 565.

A lifting block fastening part 545 to which the lifting block 561 is fastened may be provided on the guide plate 540, and the lifting block 561 may be mounted on the lifting block fastening part 545 of the guide plate 540 such that an upper portion of the lifting block 561 is exposed to an inner side of the guide plate 540 and a lower portion of the lifting block 561 is positioned on an outer side of the guide plate 540. The inner side of the guide plate 540 may be provided with a groove in which the lifting block 561 and the lifting protrusion 245 are received.

An upper portion of the lifting spring 565 may be fastened to the lower portion of the lifting block 561, and a lower portion of the lifting spring 565 may be supported by the guide plate 540, at the outer side of the guide plate.

In a state in which the console cover 100 is closed, the lifting protrusion 245 provided on the side partition wall 240 of the base plate 210 may push the lifting block 561 of the lifting mechanism 560 downward and may press the lifting block 561. As the lifting block 561 is pushed downward, the lifting spring 565 is pressed, and an elastic force may be accumulated in the lifting spring 565. While the console cover opening and closing device 200 maintains the closed state of the console cover 100, the pressed state of the lifting spring 565 may be maintained, so that the accumulated elastic force may be maintained. FIG. 10A and FIG. 10B are views illustrating a state in which the lifting block 561 is pushed downward and pressed by the lifting protrusion 245.

According to the operation of the operation button unit 120 by the passenger, the console cover 100, which was maintained in a locked and closed state by the console cover opening and closing device 200, is released (i.e., unlocked) at the beginning of an opening operation, so that the pressure restraining the lifting spring 565 may be released and a restoration force may be generated.

The lifting block 561 may be instantaneously bounced upward by an upward force restored and generated from the accumulated elastic energy in the lifting spring 565. The upward force of the lifting block 561 pushes up the lifting block 561 and the lifting protrusion 245 and, accordingly, an instantaneous upward force is applied to the base plate 210, so that the console cover 100 is capable of being moved upward to a predetermined level.

As such, since the console cover 100 is moved upward to the predetermined level by using the lifting mechanism 560 at the beginning of opening operation of the console cover 100, the passenger may easily open the console cover 100 upward.

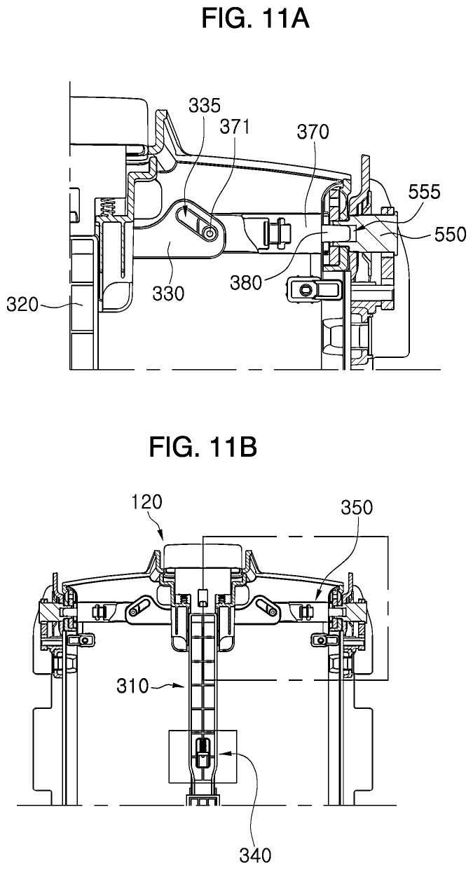

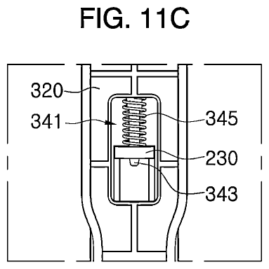

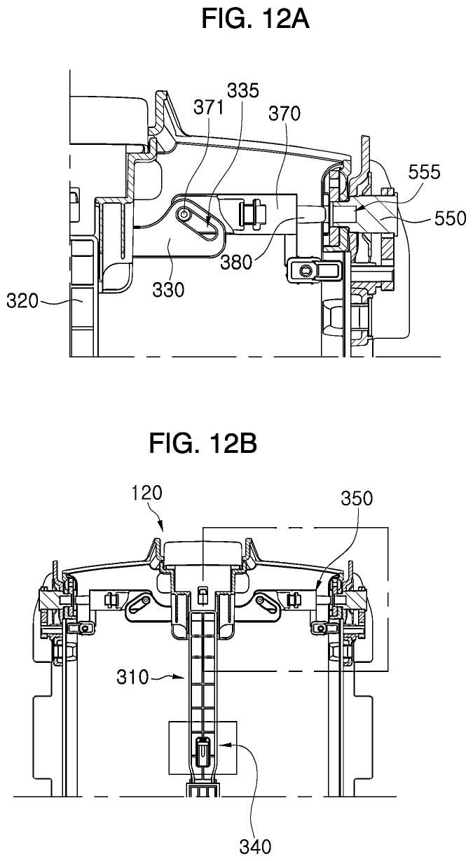

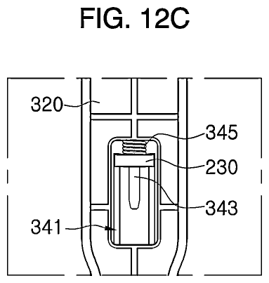

In the present disclosure, the opening and closing operation of the console cover through the console cover opening and closing device 200 will be described with reference to FIGS. 11A, 11B, 11C and FIGS. 12A, 12B, 12C.

FIGS. 11A, 11B, and 11C are views illustrating an example of a state in which the console cover is closed through the console cover opening and closing device 200. Especially, FIG. 11A is an enlarged view of a front portion of the console cover opening and closing device 200 shown in FIG. 11B, and FIG. 11C is an enlarged view of a center rod return mechanism 340 shown in FIG. 11B.

In a normal state in which the passenger does not operate the operation button unit 120, an initial position of the rod member 310 may be maintained, and the locking control unit 350 may maintain a closed state so that the console cover 100 is locked and not opened by impact or shaking.

More specifically, in a state in which the passenger does not operate the operation button unit 120, the first side (i.e., front end) of the center rod return spring 345 of the center rod return mechanism 340 moves the center rod 320 in the longitudinal direction (i.e., forward) by the elastic force while the center rod return spring 345 is supported on the center rod return support protrusion 230, so that the initial position of the center rod 320 may be maintained.

As the initial position of the center rod 320 is maintained by a support from the center rod return mechanism 340, the guide hole 335 of the wing 330 may guide the locking adjustment protrusion 371 of the locking adjustment member 370 to an initial position. Here, the initial position of the locking adjustment protrusion 371 may be a lower end in the diagonal direction of the guide hole 335 (i.e., a rearmost and outermost position in the guide hole 335).

According to the guide of the guide hole 335, the initial position of the locking adjustment protrusion 371 may be maintained, and the locking adjustment member 370 in the initial position may be moved and positioned on the outermost in the horizontal direction within a movable range.

As the locking adjustment member 370 is moved and positioned on the outermost side in the horizontal direction, the locking rod 380 may also be moved to the outermost side in the horizontal direction within a movable range, and the locking rod 380 may be inserted into and fixed to the locking hole 555 provided in the catching member 550 of the guide plate 540.

That is, in the normal state in which the passenger does not operate the operation button unit 120, the initial position of the center rod 320 is maintained by the center rod return mechanism 340, the locking adjustment protrusion 371 of the locking adjustment member 370 is positioned at the outermost side in the horizontal direction within the movable range according to the guide of the guide hole 335 of the wing 330 in the initial position of the center rod 320, and the locking rod 380 is positioned at the outermost side in the horizontal direction within the movable range by the locking adjustment member 370 and the locking rod 380 is inserted into the locking hole 555 provided in the catching member 550 of the guide plate 540 such that the position of the locking rod 380 is fixed and maintained, so that the closed state of the console cover 100 may be maintained stably.

FIGS. 12A, 12B, and 12C are views illustrating an example of a state in which the console cover is opened (i.e., unlocked) through the console cover opening and closing device 200. Especially, FIG. 12A is an enlarged view of a front portion of the console cover opening and closing device 200 shown in FIG. 12B, and FIG. 12C is an enlarged view of a center rod return mechanism 340 shown in FIG. 12B.

In an operation state in which the passenger operates the operation button unit 120, the rod member 310 may be pushed rearward in the longitudinal direction and is moved to an operation position, and the locking control unit 350 may be configured to open (i.e., unlock) the console cover 100 by the movement of the rod member 310.

More specifically, when the passenger operates the operation button unit 120, the center rod 320 may be pushed rearward in the longitudinal direction by the operation button unit 120, and the center rod 320 may be moved to the operation position.

As the center rod 320 is moved rearward in the longitudinal direction to the operation position, the wing 330 may be moved accordingly, and the locking adjustment protrusion 371 may be pulled inward in the horizontal direction and may be moved to the operation position according to the guide of the guide hole 335 of the wing 330. Here, the operation position of the locking adjustment protrusion 371 may be an upper end in the diagonal direction of the guide hole 335 (i.e., a frontmost and innermost position in the guide hole 335).

The locking adjustment protrusion 371 may be moved to the operation position according to the guide of the guide hole 335, and the locking adjustment member 370 may be moved to the innermost side in the horizontal direction within the movable range according to the movement of the locking adjustment protrusion 371.

As the locking adjustment member 370 is moved to the innermost side in the horizontal direction, the locking rod 380 may also be moved to the innermost side in the horizontal direction within the movable range, and the catching part 381 of the locking rod 380 may be pulled out from the locking hole 555 provided in the catching member 550 of the guide plate 540.

That is, in the operation state in which the passenger operates the operation button unit 120, the center rod 320 is moved rearward from the initial position to the operation position by the operation button unit 120, the locking adjustment protrusion 371 of the locking adjustment member 370 is moved to the innermost side in the horizontal direction within the movable range according to the guide of the guide hole 335 of the wing 330 while the center rod 320 is moved, and the locking rod 380 is moved to the innermost side in the horizontal direction within the movable range by the locking adjustment member 370 and the locking rod 380 is pulled out from the locking hole 555 provided in the catching member 550 of the guide plate 540, so that the closed state of the console cover 100 may be released and the console cover 100 may be opened (i.e., unlocked).

In addition, when the operation of the operation button unit 120 by the passenger is released, the center rod 320 is moved back from the operation position to the initial position by the elastic force from the center rod return mechanism 340. Furthermore, as the center rod 320 is moved to the initial position, the locking control unit 350 may return the console cover 100 to the closed state. Since the closed state of the console cover 100 through the locking control unit 350 is the same as description with reference to FIGS. 11A, 11B, and 11C, a detailed description of the closed state of the console cover 100 will be omitted.

Furthermore, in the present disclosure, the amount of operation work required for the operation button unit 120 for opening the console cover 100 can be adjusted. This adjustment process will be described in subsequent embodiments.

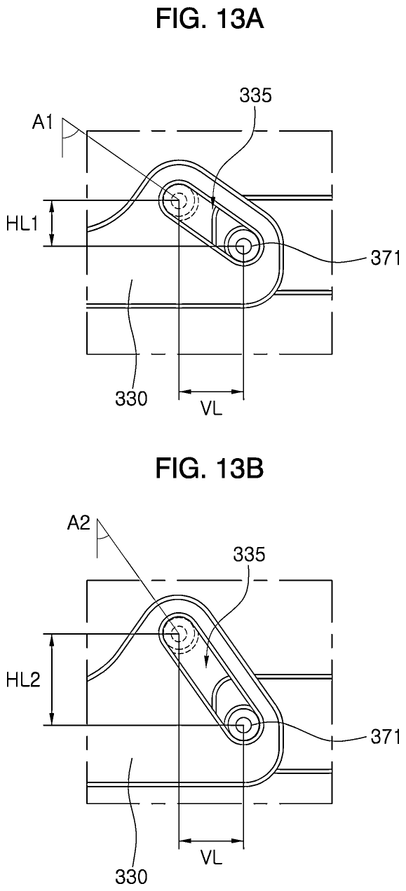

FIG. 13A to FIG. 16B are views illustrating various embodiments of the console cover opening and closing device for adjusting the amount of operation work for opening the console cover in the console device according to the present disclosure. In describing the present embodiment, an embodiment illustrated in FIGS. 11A, 11B, 11C to FIGS. 12A, 12B, 12C will be referred to together.

As described above, opening and closing of the console cover 100 may be controlled by moving the locking adjustment protrusion 371 according to the guide of the guide hole 335 provided in the wing 330 of the center rod 320. In the present disclosure, by adjusting the guide hole 335 provided in the wing 330, the amount of operation work required for opening the console cover 100 may be adjusted. Here, the amount of operation work refers to the amount of work required by the passenger in operating the operation button unit 120 for opening the console cover 100.

As an example, referring to FIG. 13A and FIG. 13B, in a situation in which the locking adjustment protrusion 371 is positioned at the lower end in the diagonal direction of the guide hole 335 (i.e., rearmost and outermost position in the guide hole 335), the console cover 100 may be in the normal state in which the closed state of the console cover 100 is maintained. In addition, in a situation in which the locking adjustment protrusion 371 is positioned at the upper end in the diagonal direction of the guide hole 335 (i.e., frontmost and innermost position in the guide hole 335), the console cover 100 may be in the operation state in which the console cover 100 is opened.

As the locking adjustment protrusion 371 is moved between the lower end and the upper end in the diagonal direction of the guide hole 335, the normal state in which the console cover 100 is closed and the operation state in which the console cover 100 is opened may be switched.

In the normal state in which the console cover 100 is closed, a stable closure may be maintained when the locking rod 380 is inserted into the locking hole 555 of the catching member 550 by a level equal to or more than a predetermined level. Furthermore, in order for the console cover 100 to be switched to the operation state in which the console cover 100 is opened, the locking rod 380 is required to be fully pulled out from the locking hole 555 of the catching member 550.

The movable range of the locking adjustment protrusion 371 in the guide hole 335 may correspond to the movable range between the position of the locking rod 380 in the normal state for maintaining the closure and the position of the locking rod 380 in the operation state for opening.

That is, a horizontal length VL of the diagonally oriented guide hole 335 may be a horizontal movable range of the locking adjustment protrusion 371. Also, the horizontal length VL may correspond to the movable range of the locking rod 380.

In addition, vertical lengths HL1 and HL2 of the diagonally oriented guide hole 335 may be a distance in which the operation button body 130 of the operation button unit 120 is moved according to the operation of the passenger, and the vertical lengths HL1 and HL2 may correspond to the movement distance in the longitudinal direction of the center rod 320. Throughout the specification, a vertical length of an object means a length of the object measured in the longitudinal direction.

According to an embodiment, a horizontal length element among the elements for the diagonally oriented guide hole 335 may be maintained as same as the VL in consideration of the movable distance of the locking rod 380 and a vertical length element among the elements for the diagonal direction of the guide hole 335 may be adjusted, so that the amount of operation work required for the operation button unit 120 for opening the console cover 100 may be adjusted.

As an example, the vertical length element of the guide hole 335 may be adjusted to the HL1 having a relatively short length or may be adjusted to the HL2 having a relatively long length. This may be understood as maintaining the horizontal length element as same as the VL and adjusting an angle inclined in the diagonal direction with respect to the longitudinal direction to A1 or A2.

As such, by adjusting the angle of the guide hole 335 inclined in the diagonal direction, the amount of operation work required for the operation button unit 120 for opening the console cover 100 may be adjusted. That is, by adjusting the guide hole 335, the work amount required by the passenger to open the console cover 100 may be adjusted.

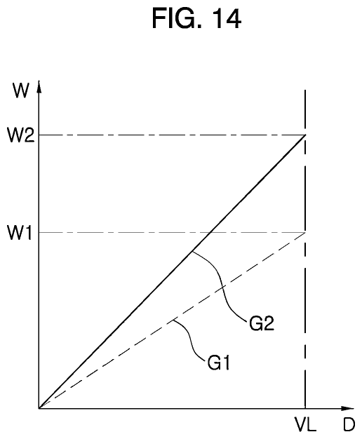

Referring to FIG. 14, the X-axis refers to a movement distance D of the locking rod 380, the Y-axis refers to an amount of operation work W applied to the operation button unit 120, a graph G1 is a graph corresponding to FIG. 13A, and a graph G2 is a graph corresponding to FIG. 13B.

In order to open the console cover 100, the locking rod 380 is required to be moved by a movement distance VL. Accordingly, in FIG. 13A, in order to move the locking rod 380 by the movement distance VL, the center rod 320 is required to be moved by HL1 in the longitudinal direction. To this end, the console cover 100 is capable of being opened only when the amount of operation work corresponding to the movement distance HL1 of the center rod 320 is applied to the operation button unit 120.

In contrast, in FIG. 13B, in order to move the locking rod 380 by the movement distance VL, the center rod 320 is required to be moved by the HL2 in the longitudinal direction. Accordingly, the console cover 100 is capable of being opened only when the amount of operation work W2 corresponding to the movement distance HL2 of the center rod 320 is applied to the operation button unit 120.

That is, in FIG. 13A, the console cover 100 is capable of being opened when the passenger applies the relatively small amount of operation work W1, so that the passenger is capable of opening the console cover 100 by operating the operation button unit 120 with a relatively small force. In contrast, in FIG. 13B, the console cover 100 is capable of being opened when the passenger applies the relatively large amount of operation work W2, so that the passenger is capable of opening the console cover 100 by operating the operation button unit 120 with a relatively large force.

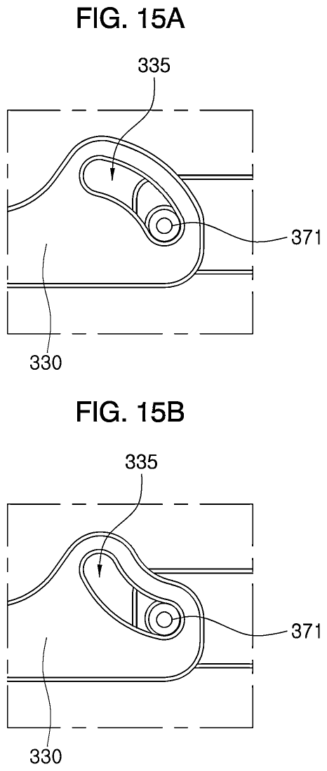

As another example, referring to FIG. 15A and FIG. 15B, the amount of operation work required for operating the operation button unit 120 for opening the console cover 100 may be adjusted by forming the guide hole 335 in an arc shape.

FIG. 15A is a case in which the guide hole 335 is formed in an arc shape that protrudes forward in the diagonal direction. In FIG. 15A, the movement distance of the locking rod 380 is not large at the beginning when the passenger begins to operate the operation button unit 120, and the movement distance of the locking rod 380 becomes large after a predetermined point in time.

That is, in the guide hole 335 formed in the arc shape that protrudes forward in the diagonal direction, the horizontal movement of the locking adjustment protrusion 371 is small and the vertical movement of the locking adjustment protrusion 371 is large at the beginning of the movement of the locking adjustment protrusion 371 moved through the guide of the guide hole 335 according to the start of the operation of the operation button unit 120 from the normal state position, so that the amount of operation work required by the passenger is not significantly required to move the locking rod 380.

As the locking adjustment protrusion 371 passes a middle end of the guide hole 335 and is moved close to an end of the guide hole 335, the vertical movement of the locking adjustment protrusion 371 becomes small and the horizontal movement of the locking adjustment protrusion 371 becomes large, so that the amount of operation work required by the passenger is accordingly required to move the locking rod 380.

FIG. 15B is a case in which the guide hole 335 is formed in an arc shape that protrudes rearward in the diagonal direction. In FIG. 15B, the movement distance of the locking rod 380 is large at the beginning when the passenger begins to operate the operation button unit 120, and the movement distance of the locking rod 380 becomes small after a predetermined point in time.

That is, in the guide hole 335 formed in the arc shape that protrudes rearward in the diagonal direction, the vertical movement of the locking adjustment protrusion 371 is small and the horizontal movement of the locking adjustment protrusion 371 is large at the beginning of the movement of the locking adjustment protrusion 371 moved through the guide of the guide hole 335 according to the start of the operation of the operation button unit 120 from the normal state position, so that the amount of operation work required by the passenger is accordingly required to move the locking rod 380.

As the locking adjustment protrusion 371 passes the middle end of the guide hole 335 and is moved close to the end of the guide hole 335, the horizontal movement of the locking adjustment protrusion 371 becomes small and the vertical movement of the locking adjustment protrusion 371 becomes large, so that the amount of operation work required by the passenger is not significantly required to move the locking rod 380.

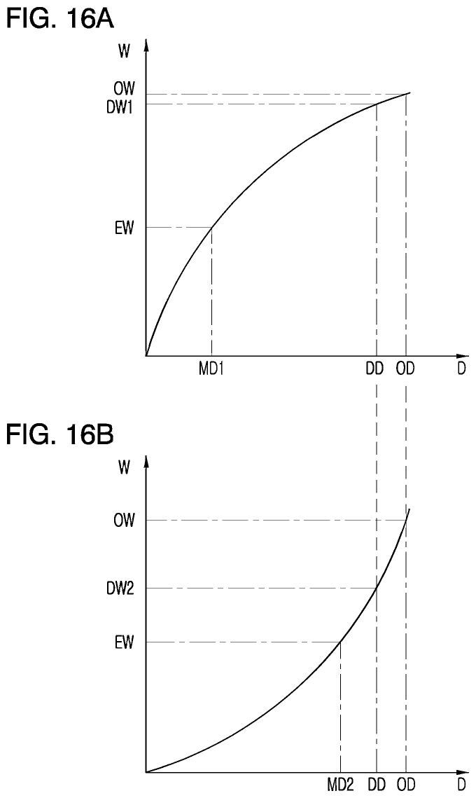

Referring to FIG. 16A and FIG. 16B, the X-axis refers to the movement distance D of the locking rod 380, the Y-axis refers to the amount of operation work W applied to the operation button unit 120, a graph shown in FIG. 16A is a graph corresponding to FIG. 15A, and a graph shown in FIG. 16B is a graph corresponding to FIG. 15B.

When the passenger applies the amount of operation work of EW for a predetermined time from the beginning of operating the operation button unit 120, the movement distance of the locking rod 380 reaches MD1 in the guide hole 335 as illustrated in FIG. 15A, and the movement distance of the locking rod 380 reaches MD2 in the guide hole 335 as illustrated in FIG. 15B.

That is, from the beginning when the passenger operates the operation button unit 120 to a predetermined point, when the passenger applies the same amount of operation work as EW, the locking rod 380 is moved more when the guide hole 335 as shown in FIG. 15B than when the guide hole 335 as shown in FIG. 15A is applied.

In addition, until the locking rod 380 reaches a critical position DD where the locking rod 380 is capable of being easily deviated from the locking hole 555 by a small impact or small shaking, a relatively large amount of operation work of DW1 is required when the guide hole 335 as shown in FIG. 15A is applied, but a relatively small amount of operation work of DW2 is required when the guide hole 335 as shown in FIG. 15B is applied.

Looking at the overall perspective, in both cases in FIG. 15A and FIG. 15B, in order for the locking rod 380 to reach a distance OD where the locking rod 380 is fully pulled out from the locking hole 555, the same amount of operation work as OW may be required for the operation button unit 120.

However, even though the same amount of operation work as EW is applied to the operation button unit 120 at the beginning of operating the operation button unit 120, the locking rod 380 is moved much more in the case in FIG. 15B than in the case in FIG. 15A, and the locking rod 380 in the case in FIG. 15B reaches the critical position DD when the relatively small amount of operation work of DW2 is applied.

That is, when the guide hole 335 is formed in the arc shape that protrudes forward in the diagonal direction, the console cover 100 is not opened by a small force applied from the passenger, an impact, and so on, so that the locked state of the console cover 100 is more stably maintained.

As described above, in the present disclosure, the amount of operation work required for the operation button unit 120 for opening the console cover 100 is capable of being adjusted by adjusting an angle inclined in the diagonal direction relative to the longitudinal direction with respect to the guide hole 335 provided in the wing 330 or by forming the guide hole 335 in the arc shape that protrudes forward or rearward in the diagonal direction, so that an operation feeling that the passenger feels when the passenger operates the operation button unit 120 is capable of being variously modified and also the closed state of the console cover 100 is capable of being stably maintained.

In addition, in the console device according to the present disclosure, when either the front or rear operation button unit of the console cover is operated, a console opening direction adjustment unit is applied to restrict the operation of the other button, preventing the console cover being opened in both front and rear directions simultaneously. This mechanism will be described with reference to a subsequent embodiment.

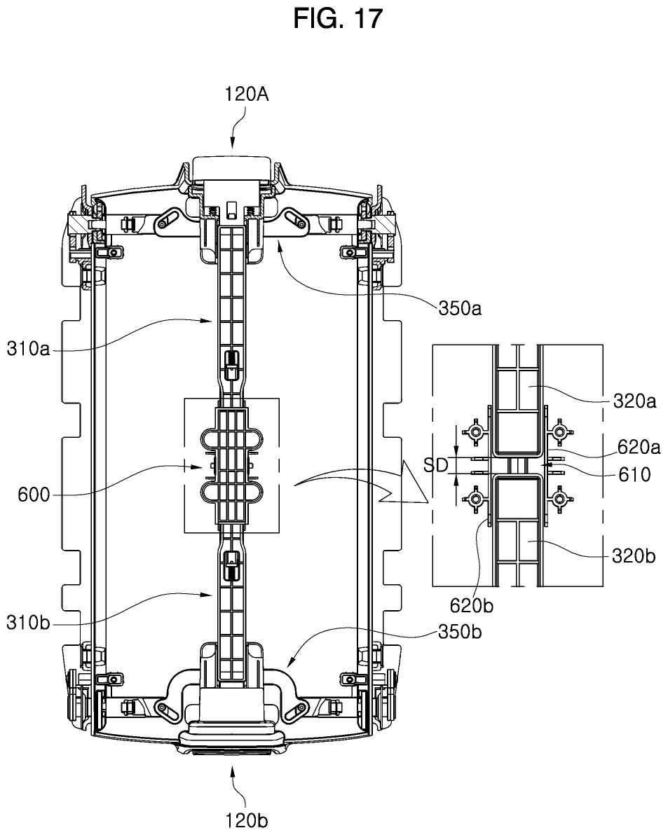

FIG. 17 is a view illustrating an embodiment in a state in which the both sides of the console cover are closed by using the console cover opening and closing device 200 for opening the console cover in the front direction and the rear direction in the console device 10 according to the present disclosure.

The front operation button unit 120a, the front rod member 310a, and the front locking control unit 350a may be included in the console cover 100 for opening and closing the console cover in the front direction.

In addition, the rear operation button unit 120b, the rear rod member 310b, and the rear locking control unit 350b may be included in the console cover 100 for opening and closing the console cover in the rear direction.

The front operation button unit 120a, the front rod member 310a, the front locking control unit 350a, the rear operation button unit 120b, the rear rod member 310b, and the rear locking control unit 350b may be disposed symmetrically to each other in the front direction and the rear direction.

The front center rod 320a of the front rod member 310a and the rear center rod 320b of the rear rod member 310b may be disposed on a same vertical line along the longitudinal direction such that each distal end of the front center rod 320a and the rear center rod 320b correspond to each other.

The console opening direction adjustment unit 600 may be disposed between the distal end region of the front center rod 320a of the front rod member 310a and the distal end region of the rear center rod 320b of the rear rod member 310b.

Referring to an inner enlarged view of the console opening direction adjustment unit 600, the console opening direction adjustment unit 600 may include guide partition walls 620a and 620b, which guide the longitudinal movement of the front center rod 320a and the rear center rod 320b. The console opening direction adjustment unit 600 may also include an open space 610 where the distal end of either the front center rod 320a or the rear center rod 320b can move in.

Here, a length SD of the open space 610 in the longitudinal direction may correspond to a movement length in which any one among the front center rod 320a and the rear center rod 320b is capable of being moved in the longitudinal direction according to the operation of any one selected from the front operation button unit 120a and the rear operation button unit 120b.

That is, when the both sides of the console cover are closed, a separation distance where the distal end of the front center rod 320a and the distal end of the rear center rod 320b, which come into contact with each other when the console cover is opened in either direction, may be set as the length SD of the open space 610.

As illustrated in FIG. 17, in a state in which the front side of the console cover is closed by the front locking control unit 350a and also the rear side of the console cover is closed by the rear locking control unit 350b, the separation distance between the distal end of the front center rod 320a and the distal end of the rear center rod 320b may be maintained as the SD by the console opening direction adjustment unit 600.

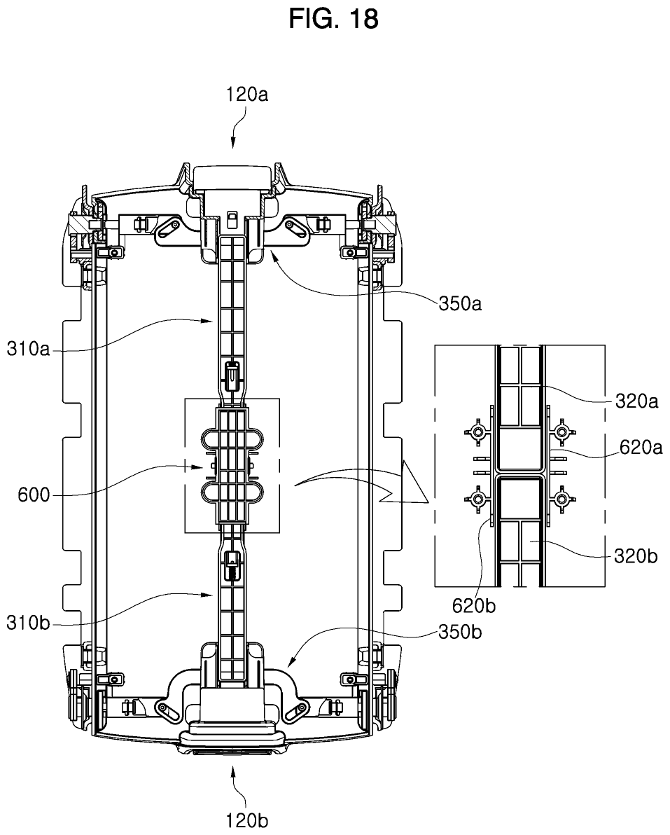

FIG. 18 is a view illustrating an embodiment in a state in which the front side of the console cover is opened (i.e., unlocked) and the rear side of the console cover remains closed by the console cover opening and closing device 200 for opening the console cover in the console device according to the present disclosure.

According to the operation of the front operation button unit 120a, the front center rod 320a of the front rod member 310a is pushed and moved rearward in the longitudinal direction. The distal end region of the front center rod 320a may be guided by the guide partition walls 620a and 620b and may be moved rearward in the longitudinal direction, so that the distal end region of the front center rod 320a may be in contact with the distal end of the rear center rod 320b.

The locking rod of the front locking control unit 350a may be pulled out from the locking hole according to the movement of the front center rod 320a, so that the front side of the console cover is capable of being opened.

In a state in which the front side of the console cover is opened, the distal end of the front center rod 320a and the distal end of the rear center rod 320b are in contact with each other by the console opening direction adjustment unit 600, so that the movement of the rear center rod 320b is restricted.

That is, in a state in which the front side of the console cover is opened, the rear center rod 320b cannot be moved forward due to the console opening direction adjustment unit 600. The rear center rod 320b cannot be moved even when the rear operation button unit 120b is operated, thereby opening of the rear side of the console cover is restricted when the front side of the console cover is opened.

Similarly, in a state in which the rear side of the console cover is opened, the front center rod 320a cannot be moved rearward due to the console opening direction adjustment unit 600. The front center rod 320a cannot be moved even when the front operation button unit 120a is operated, thereby opening of the front side of the console cover is restricted when the rear side of the console cover is opened.

As such, the present disclosure addresses the issue of the console cover opening simultaneously on both the front and rear sides, potentially detaching from the console body, by adopting the console opening direction adjustment unit that selectively controls the opening direction in a console device while the console device is operable to open in both directions.

As described through the embodiments of the present disclosure, in the present disclosure, opening and closing of the console cover may be stably and reliably performed.

Particularly, since the guide hole in the diagonal direction is provided in the rod member that is moved in the longitudinal direction according to the operation of the operation button such that the horizontal movement of the locking rod is controlled through the guide of the guide hole, opening and closing of the console cover may be stably and reliably performed with a simple structure.

Furthermore, since the amount of operation work required for the operation button unit for opening the console cover may be adjusted by adjusting the angle inclined in the diagonal direction of the guide hole guiding opening of the console cover or by forming the guide hole in the arc shape that protrudes forward or rearward in the diagonal direction, and the operation feeling may be variously modified accordingly.

Although the embodiments of the present disclosure have been disclosed for illustrative purposes, those skilled in the art will appreciate that various modifications, additions, and substitutions are possible, without departing from the scope and spirit of the present disclosure. Also, it is noted that any one feature of an embodiment of the present disclosure described in the specification may be applied to another embodiment of the present disclosure. Similarly, the present invention encompasses any embodiment that combines features of one embodiment and features of another embodiment. Accordingly, embodiments disclosed in the present disclosure are provided for describing the present disclosure and are not intended to limit the technical ideas of the present disclosure. The technical ideas of the present disclosure are not limited to the embodiments. The scope of the present disclosure should be construed as being covered by the scope of the appended claims, and all technical ideas falling within the scope of the claims should be construed as being included in the scope of the present disclosure.

What is claimed is:

1. A console device comprising:
a rod member configured to be moved in a longitudinal direction according to an operation of an operation button unit that performs opening of a console cover, the rod member being provided with a guide hole having a predetermined length in a diagonal direction relative to the longitudinal direction;
a locking control unit provided with a locking adjustment protrusion inserted into and coupled to the guide hole, the locking control unit being configured to be moved in a horizontal direction according to a guide of the guide hole upon the rod member's longitudinal movement such that a portion of a distal end of a locking rod of the locking control unit is inserted into or pulled out from a locking hole of a console body, thereby controlling locking and releasing of the console cover; and
a base plate on which the rod member and the locking control unit are seated and supported.

2. The console device of claim 1, wherein the rod member comprises:
a center rod elongated in the longitudinal direction; and
a wing which extends outward from side surfaces of the center rod and which is provided with the guide hole, and
wherein the locking control unit comprises:
a locking adjustment member having a first side provided with the locking adjustment protrusion and being configured to be moved in the horizontal direction according to the guide of the guide hole; and
the locking rod fastened to a second side of the locking adjustment member and configured to be moved by the locking adjustment member such that the portion of the distal end of the locking rod is inserted into or pulled out from the locking hole of the console body.

3. The console device of claim 2, wherein the wing comprises a left wing and a right wing on both left and right sides of the center rod, and the locking control unit comprises a left locking control unit corresponding to the left wing and a right locking control unit corresponding to the right wing.

4. The console device of claim 2, wherein the locking control unit further comprises a support plate which is fixed and fastened to the base plate and which provides a movement space of the center rod in the longitudinal direction, the support plate being configured to support the locking adjustment member and to support the movement in the horizontal direction of the locking adjustment member, and
the operation button unit comprises an operation button body, an operation button cover fixed and mounted on the support plate and configured to support the operation button body and to support a movement in the longitudinal direction of the operation button body, and an operation button return spring having a first side fastened to the operation button body and having a second side fastened to the operation button cover such that a position of the operation button body is returned.

5. The console device of claim 2, wherein the rod member further comprises a center rod return mechanism having a first side fastened to the center rod and having a second side fastened to the base plate such that an elastic force is applied to the center rod return mechanism as the center rod return mechanism is pressed according to the movement of the center rod, the center rod return mechanism being configured to return a position of the center rod by a restoration force according to the elastic force.

6. The console device of claim 2, wherein the guide hole is configured such that an angle of the guide hole inclined in the diagonal direction relative to the longitudinal direction is adjusted, so that an amount of operation work required for the operation button unit for opening the console cover is adjusted.

7. The console device of claim 2, wherein the guide hole is configured such that the guide hole is formed in an arc shape that protrudes forward in the diagonal direction or in an arc shape that protrudes rearward in the diagonal direction, so that an amount of operation work required for the operation button unit for opening the console cover is adjusted.

8. The console device of claim 2,
wherein the operation button unit comprises a front operation button unit and a rear operation button unit,
wherein the rod member and the locking control unit comprise:
a front rod member and a front locking control unit that are disposed on a front region of the base plate such that a front side of the console cover is capable of being opened according to an operation of the front operation button unit; and
a rear rod member and a rear locking control unit that are disposed on a rear region of the base plate such that a rear side of the console cover is capable of being opened according to an operation of the rear operation button unit.

9. The console device of claim 8, wherein, when the front side of the console cover is opened, a rear locking rod of the rear locking control unit is rotated while being in a state in which a portion of a distal end of the rear locking rod is inserted into a rear locking hole of the console body, so that the rear locking rod functions as a hinge, and
when the rear side of the console cover is opened, a front locking rod of the front locking control unit is rotated while being in a state in which a portion of a distal end of the front locking rod is inserted into a front locking hole of the console body, so that the front locking rod functions as a hinge.

10. The console device of claim 8, wherein a front center rod of the front rod member and a rear center rod of the rear rod member are disposed such that a distal end of the front center rod and a distal end of the rear center rod correspond to each other along the longitudinal direction, and the console device further comprises a console opening direction adjustment unit disposed between the front center rod and the rear center rod and configured to restrict, when the console cover is opened in either one of a front direction and a rear direction, the console cover from being opened in an opposite direction.

11. The console device of claim 10, wherein the console opening direction adjustment unit comprises:
a guide partition wall configured to guide the movement in the longitudinal direction of the front center rod and the rear center rod; and
an open space in which the distal end of any one selected from the front center rod and the rear center rod is capable of being moved therein,
wherein the open space has a length where the distal end of any one among the front center rod and the rear center rod is moved and is in contact with the distal end of the other one so as to open the console cover in any one direction selected from the front direction and the rear direction.

12. The console device of claim 2, further comprising a lifting mechanism which is disposed in the console body and in which an elastic force is applied as the lifting mechanism is pressed by the console cover when the console cover is closed, the lifting mechanism being configured to lift up the console cover by a restoration force when the console cover is opened.

13. The console device of claim 2, wherein the guide hole is in a long hole shape and is diagonally oriented such that a front end of the guide hole is positioned relatively inner side than a rear end of the guide hole.
